(19) United States
(12) Patent Application Publication
(10) Pub. No.: US 2021/0252939 A1
(43) Pub. Date: Aug. 19, 2021

(54) AUTOMATIC TRANSPORTATION REFRIGERATION UNIT SETTINGS FOLLOWING REAL TIME LOCATION

(71) Applicant: Carrier Corporation, Palm Beach Gardens, FL (US)

(72) Inventor: Loic Renault, Saint Etienne du Rouvray (FR)

(21) Appl. No.: 17/048,871

(22) PCT Filed: Apr. 20, 2018
(86) PCT No.: PCT/IB2018/000569

§ 371 Date: Oct. 19, 2020

(51) Int. Cl. B60H 1/00; B60H 1/32

(52) U.S. Cl. CPC B60H 1/00771; B60H 1/3232

(57) ABSTRACT

A method of operating a refrigeration unit of a transport refrigeration system is provided. The method including: monitoring at least one of a real-time location of a refrigeration unit and a current time; and adjusting operation of the refrigeration unit in response to at least one of the real-time location of the refrigeration unit and the current time, the operation of the refrigeration unit is adjusted to change a level of noise emanating from the refrigeration unit.

### BACKGROUND

The subject matter disclosed herein generally relates to the field of transportation refrigeration systems, and more particularly to an apparatus and method of operating the fuel systems of such transport refrigeration systems.

Typically, cold chain distribution systems are used to transport and distribute cargo, or more specifically perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated vehicles and trailers are commonly used to transport perishable goods in a cold chain distribution system. A transport refrigeration system is mounted to the vehicles or to the trailer in operative association with a cargo space defined within the vehicles or trailer for maintaining a controlled temperature environment within the cargo space.

Conventionally, transport refrigeration systems used in connection with refrigerated vehicles and refrigerated trailers include a refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

On commercially available transport refrigeration systems used in connection with refrigerated vehicles and refrigerated trailers, the compressor, and typically other components of the refrigeration unit, must be powered during transit by a prime mover. In mechanically driven transport refrigeration systems the compressor is driven by the prime mover, either through a direct mechanical coupling or a belt drive, and other components, such as the condenser and evaporator fans are belt driven.

Conventional refrigeration units may generate variable levels of noise. Noise regulations across of globe are being implemented and refrigeration unit must operate within these local noise regulations.

### BRIEF DESCRIPTION

### THIS SECTION TO BE COMPLETED WHEN THE CLAIMS ARE FINALIZED

According to one embodiment, a method of operating a refrigeration unit of a transport refrigeration system is provided. The method including: monitoring at least one of a real-time location of a refrigeration unit and a current time; and adjusting operation of the refrigeration unit in response to at least one of the real-time location of the refrigeration unit and the current time, the operation of the refrigeration unit is adjusted to change a level of noise emanating from the refrigeration unit.

In addition to one or more of the features described above, or as an alternative, further embodiments may include that the operation of the refrigeration unit is adjusted in response to the real-time location of the refrigeration unit.

In addition to one or more of the features described above, or as an alternative, further embodiments may include that the operation of the refrigeration unit is adjusted in response to the current time.

In addition to one or more of the features described above, or as an alternative, further embodiments may include that the operation of the refrigeration unit is adjusted in response to the real-time location of the refrigeration unit and the current time.

In addition to one or more of the features described above, or as an alternative, further embodiments may include that adjusting operation of the refrigeration unit further includes: adjusting an RPM of a prime mover configured to power the refrigeration unit.

In addition to one or more of the features described above, or as an alternative, further embodiments may include that adjusting operation of the refrigeration unit further includes: adjusting engine load of a prime mover configured to power the refrigeration unit.

In addition to one or more of the features described above, or as an alternative, further embodiments may include that the real-time location of the refrigeration unit is monitored using a global positioning system.

According to another embodiment, a controller for a refrigeration unit of a transport refrigeration system is provided. The controller including: a processor; a memory including computer-executable instructions that, when executed by the processor, cause the processor to perform operations, the operations including: monitoring at least one of a real-time location of a refrigeration unit and a current time; and adjusting operation of the refrigeration unit in response to at least one of the real-time location of the refrigeration unit and the current time, the operation of the refrigeration unit is adjusted to change a level of noise emanating from the refrigeration unit.

In addition to one or more of the features described above, or as an alternative, further embodiments may include that the operation of the refrigeration unit is adjusted in response to the real-time location of the refrigeration unit.

In addition to one or more of the features described above, or as an alternative, further embodiments may include that the operation of the refrigeration unit is adjusted in response to the current time.

In addition to one or more of the features described above, or as an alternative, further embodiments may include that the operation of the refrigeration unit is adjusted in response to the real-time location of the refrigeration unit and the current time.

In addition to one or more of the features described above, or as an alternative, further embodiments may include that adjusting operation of the refrigeration unit further includes: adjusting an RPM of a prime mover configured to power the refrigeration unit.

In addition to one or more of the features described above, or as an alternative, further embodiments may include that adjusting operation of the refrigeration unit further includes: adjusting engine load of a prime mover configured to power the refrigeration unit.

In addition to one or more of the features described above, or as an alternative, further embodiments may include that the real-time location of the refrigeration unit is monitored using a global positioning system.

According to another embodiment, a computer program product tangibly embodied on a computer readable medium is provided. The computer program product including instructions that, when executed by a processor, cause the processor to perform operations including: monitoring at least one of a real-time location of a refrigeration unit and a current time; and adjusting operation of the refrigeration unit in response to at least one of the real-time location of the refrigeration unit and the current time, the operation of the refrigeration unit is adjusted to change a level of noise emanating from the refrigeration unit.

In addition to one or more of the features described above, or as an alternative, further embodiments may include that the operation of the refrigeration unit is adjusted in response to the real-time location of the refrigeration unit.

In addition to one or more of the features described above, or as an alternative, further embodiments may include that the operation of the refrigeration unit is adjusted in response to the current time.

In addition to one or more of the features described above, or as an alternative, further embodiments may include that the operation of the refrigeration unit is adjusted in response to the real-time location of the refrigeration unit and the current time.

In addition to one or more of the features described above, or as an alternative, further embodiments may include that adjusting operation of the refrigeration unit further includes: adjusting an RPM of a prime mover configured to power the refrigeration unit.

In addition to one or more of the features described above, or as an alternative, further embodiments may include that adjusting operation of the refrigeration unit further includes: adjusting engine load of a prime mover configured to power the refrigeration unit.

Technical effects of embodiments of the present disclosure include adjusting operation of the refrigeration unit in response to at least one of the real-time location of the refrigeration unit and the current time.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a schematic illustration of a transport refrigeration system, according to an embodiment of the present disclosure;

FIG. 2 is an enlarged schematic illustration of the transport refrigeration system of FIG. 1, according to an embodiment of the present disclosure; and

FIG. 3 is a flow diagram illustrating a method of operating a transportation refrigeration system, according to an embodiment of the present disclosure.

### DETAILED DESCRIPTION

A detailed description of one or more embodiments of the disclosed apparatus and method are presented herein by way of exemplification and not limitation with reference to the Figures.

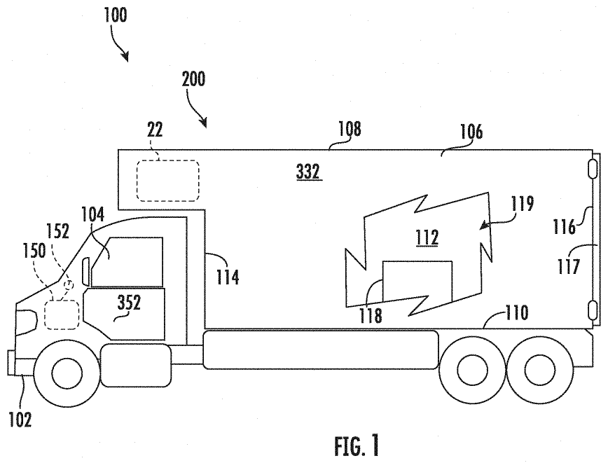

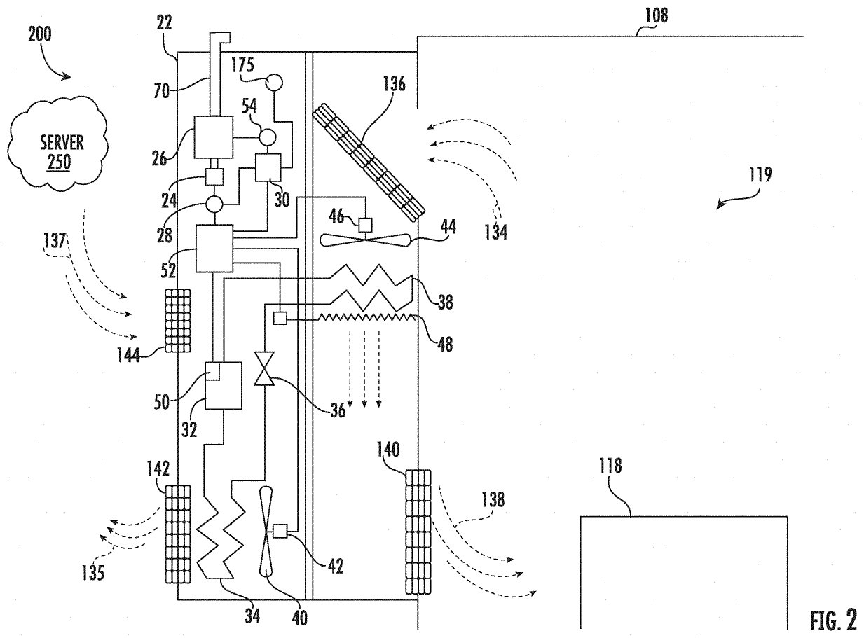

Referring to FIGS. 1-2. FIG. 1 shows a schematic illustration of a transport refrigeration system 200 and FIG. 2 shows an enlarged schematic illustration of the transport refrigeration system 200 of FIG. 1. The transport refrigeration system 200 is being illustrated as a trailer system 100 as seen in FIG. 1. The trailer system 100 includes a vehicle 102 and a transport container 106. The vehicle 102 includes an operator's compartment or cab 104 and a vehicle engine 150 which acts as the drive system of the trailer system 100. The vehicle engine 150 may include an engine controller 152 configured to control the operation of the vehicle engine 150. The engine controller 152 may be an electronic controller including a processor and an associated memory comprising computer-executable instructions that, when executed by the processor, cause the processor to perform various operations. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be a storage device such as, for example, a random access memory (RAM), read only memory (ROM), or other electronic, optical, magnetic or any other computer readable medium. The fuel that powers the vehicle engine 150 may be a combustible fuel such as for example, compressed natural gas, liquefied natural gas, gasoline, diesel, biodiesel, etc.

The transport container 106 is coupled to the vehicle 102. The transport container 106 is a refrigerated trailer and includes a top wall 108, a directly opposed bottom wall 110, opposed side walls 112, and a front wall 114, with the front wall 114 being closest to the vehicle 102. The transport container 106 further includes a door or doors 117 at a rear wall 116, opposite the front wall 114. The walls of the transport container 106 define a refrigerated cargo space 119. It is appreciated by those of skill in the art that embodiments described herein may be applied to non-trailer refrigeration such as, for example a rigid truck or a truck having refrigerate compartment.

Typically, transport refrigeration systems 200 are used to transport and distribute perishable goods and environmentally sensitive goods (herein referred to as perishable goods 118). The perishable goods 118 may include but are not limited to fruits, vegetables, grains, beans, nuts, eggs, dairy, seed, flowers, meat, poultry, fish, ice, blood, pharmaceuticals, or any other suitable cargo requiring temperature controlled transport.

As seen in FIG. 2, the transport refrigeration system 200 includes a refrigeration unit 22, an electric generation device 24, a prime mover 26 for driving the electric generation device 24, and a controller 30. The refrigeration unit 22 functions, under the control of the controller 30, to establish and regulate a desired environmental parameters, such as, for example temperature, pressure, humidity, carbon dioxide, ethylene, ozone, light exposure, vibration exposure, and other conditions in the interior compartment 119 as known to one of ordinary skill in the art. In an embodiment, the refrigeration unit 22 is a refrigeration system capable of providing a desired temperature and humidity range.

The refrigeration unit 22 includes a refrigerant compression device 32, a refrigerant heat rejection heat exchanger 34, an expansion device 36, and a refrigerant heat absorption heat exchanger 38 connected in refrigerant flow communication in a closed loop refrigerant circuit and arranged in a conventional refrigeration cycle. The refrigeration unit 22 also includes one or more fans 40 associated with the refrigerant heat rejection heat exchanger 34 and driven by fan motor(s) 42 and one or more fans 44 associated with the refrigerant heat absorption heat exchanger 38 and driven by fan motor(s) 46. The refrigeration unit 22 may also include a heater 48 associated with the refrigerant heat absorption heat exchanger 38. In an embodiment, the heater 48 may be an electric resistance heater. It is to be understood that other components (not shown) may be incorporated into the refrigerant circuit as desired, including for example, but not limited to, a suction modulation valve, a receiver, a filter/dryer, an economizer circuit.

The refrigerant heat rejection heat exchanger 34 may, for example, comprise one or more refrigerant conveying coiled tubes or one or more tube banks formed of a plurality of refrigerant conveying tubes across flow path to the heat outlet 142. The fan(s) 40 are operative to pass air, typically ambient air, across the tubes of the refrigerant heat rejection heat exchanger 34 to cool refrigerant vapor passing through the tubes. The refrigerant heat rejection heat exchanger 34 may operate either as a refrigerant condenser, such as if the refrigeration unit 22 is operating in a subcritical refrigerant cycle or as a refrigerant gas cooler, such as if the refrigeration unit 22 is operating in a transcritical cycle.

The refrigerant heat absorption heat exchanger 38 may, for example, also comprise one or more refrigerant conveying coiled tubes or one or more tube banks formed of a plurality of refrigerant conveying tubes extending across flow path from a return air inlet 136. The fan(s) 44 are operative to pass air drawn from the refrigerated cargo space 119 across the tubes of the refrigerant heat absorption heat exchanger 38 to heat and evaporate refrigerant liquid passing through the tubes and cool the air. The air cooled in traversing the refrigerant heat rejection heat exchanger 38 is supplied back to the refrigerated cargo space 119 through a refrigeration unit outlet 140. It is to be understood that the term “air” when used herein with reference to the atmosphere within the refrigerated cargo space 119 includes mixtures of air with other gases, such as for example, but not limited to, nitrogen or carbon dioxide, sometimes introduced into a refrigerated cargo space 119 for transport of perishable produce.

The refrigerant compression device 32 may comprise a single-stage or multiple-stage compressor such as, for example, a reciprocating compressor or a scroll compressor. The compression device 32 has a compression mechanism (not shown) driven by an electric motor 50. In an embodiment, the motor 50 may be disposed internally within the compressor with a drive shaft interconnected with a shaft of the compression mechanism, all sealed within a common housing of the compression device 32.

The transport refrigeration system 200 also includes a controller 30 configured for controlling operation of the transport refrigeration system 200 including, but not limited to, operation of various components of the refrigerant unit 22 to provide and maintain a desired thermal environment within the refrigerated cargo space 119. The controller 30 may also be able to selectively operate the prime mover 26, typically through an electronic engine controller 54 operatively associated with the prime mover 26. The controller 30 and the engine controller 54 may be electronic controllers including a processor and an associated memory comprising computer-executable instructions that, when executed by the processor, cause the processor to perform various operations. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be a storage device such as, for example, a random access memory (RAM), read only memory (ROM), or other electronic, optical, magnetic or any other computer readable medium.

The refrigeration unit 22 has a plurality of power demand loads, including, but not limited to, the compression device drive motor 50, the drive motor 42 for the fan 40 associated with the refrigerant heat rejection heat exchanger 34, and the drive motor 46 for the fan 44 associated with the refrigerant heat absorption heat exchanger 38. In the depicted embodiment, the heater 48 also constitutes a power demand load. The electric resistance heater 48 may be selectively operated by the controller 30 whenever a control temperature within the temperature controlled refrigerated cargo space 119 drops below a preset lower temperature limit, which may occur in a cold ambient environment. In such an event the controller 30 would activate the heater 48 to heat air circulated over the heater 48 by the fan(s) 44 associated with the refrigerant heat absorption heat exchanger 38. The heater 48 may also be used to de-ice the return air intake 136.

The prime mover 26 is an on-board fossil-fuel engine that drives the electric generation device 24, which generates electrical power. The fuel that powers the prime mover 26 may a combustible fuel such as for example, compressed natural gas, liquefied natural gas, gasoline, diesel, biodiesel, etc. In another embodiment, the fuel that powers the prime mover 26 is the same fuel that powers the vehicle engine 150 of the vehicle 102. Exhaust generated from the combustion of fuel within the prime mover 26 may be exhausted out of the refrigeration unit 22 through an exhaust system 70.

The drive shaft of the engine drives the shaft of the electric generation device 24. In an electrically powered embodiment of the refrigeration unit 22, the electric generation device 24 may comprise a single on-board, engine driven AC generator configured to generate alternating current (AC) power including at least one AC voltage at one or more frequencies. In an embodiment, the electric generation device 24 may, for example, be a permanent magnet AC generator or a synchronous AC generator. In another embodiment, the electric generation device 24 may comprise a single on-board, engine driven DC generator configured to generate direct current (DC) power at at least one voltage. Some electric generation devices may have internal voltage regulators while other electric generation devices do not. As each of the fan motors 42, 46 and the compression device drive motor 50 may be an AC motor or a DC motor, it is to be understood that various power converters 52, such as AC to DC rectifiers, DC to AC inverters, AC to AC voltage/frequency converters, and DC to DC voltage converters, may be employed in connection with the electric generation device 24 as appropriate. The transport refrigeration system 200 may include a voltage sensor 28 to sense the voltage of the electric generation device 24.

Airflow is circulated into and through the refrigerated cargo space 119 of the transport container 106 by means of the refrigeration unit 22. A return airflow 134 flows into the refrigeration unit 22 from the refrigerated cargo space 119 through the refrigeration unit return air intake 136, and across the refrigerant heat absorption heat exchanger 38 via the fan 44, thus conditioning the return airflow 134 to a selected or predetermined temperature. The conditioned return airflow 134, now referred to as supply airflow 138, is supplied into the refrigerated cargo space 119 of the transport container 106 through the refrigeration unit outlet 140, which in some embodiments is located near the bottom wall 110 of the container system 106. Heat 135 is removed from the refrigerant heat rejection heat exchanger 34 through the heat outlet 142. The refrigeration unit 22 may contain an external air inlet 144, as shown in FIG. 2, to aid in the removal of heat 135 from the refrigerant heat rejection heat exchanger 34 by pulling in external air 137. The supply airflow 138 cools the perishable goods 118 in the refrigerated cargo space 119 of the transport container 106. It is to be appreciated that the refrigeration unit 22 can further be operated in reverse to warm the container system 106 when, for example, the outside temperature is very low. In the illustrated embodiment, the return air intake 136, the refrigeration unit outlet 140, the heat outlet 142, and the external air inlet 144 are configured as grilles to help prevent foreign objects from entering the refrigeration unit 22.

In the illustrated embodiment, the transport refrigeration system 200 may also include a location tracking device 175 in communication with the controller 30, as seen in FIG. 2. In embodiment, the location tracking device 175 automatically and continuously tracks the real-time location of the refrigeration system 200. The location tracking device 175 may be a device such as, for example, a global positioning system configured to monitor the real-time location of the transport refrigeration system 200. The location tracking device 175 may continuously monitor the real-time location of the transport refrigeration system 200 and transmit the real time location to the controller 30, which then may adjust the operation of the refrigeration unit 22 to adjust the noise output of the refrigeration unit 22 in response to the real-time location. For example, the controller 30 may adjust the operation of the refrigeration unit 22 to reduce noise output of the refrigeration unit 22 when the real-time location of the transport refrigeration system 200 is within a selected location. Adjusting, the operation of the refrigeration unit 22 may include but is not limited to adjusting the settings of the prime mover 26. In one example, noise emanating from the refrigeration unit 22 may be reduced by adjusting engine load of the prime mover 26 by reducing compressor load and minimizing cooling capacities of the refrigeration unit 22 when necessary in low noise zone. In another example, the controller may reduce the RPM of the prime mover 26 when entering a geographical area where local noise regulations may restrict the noise output of the refrigeration unit 22. The selected location may be a location such as, for example, an urban or residential environment, where the noise generated by the prime mover 26 may be too loud and/or is regulated by noise regulations. The selected locations may be stored in the memory of the controller 30 or stored in a remote server 250 wirelessly connected to the controller 54 through a wireless network. The wireless connection may be a wireless communication method such as, for example, radio, microwave, cellular, satellite, or another wireless communication method known to one of skill in the art.

In another embodiment, the controller 30 may be configured to adjust the operation of the refrigeration unit 22 in response to a current time. For example, the refrigeration unit 22 may be traveling in a location where the noise regulations vary between day, evening, and night, thus the operation of the refrigeration unit 22 must be adjusted at various times throughout the day to comply with the different regulations.

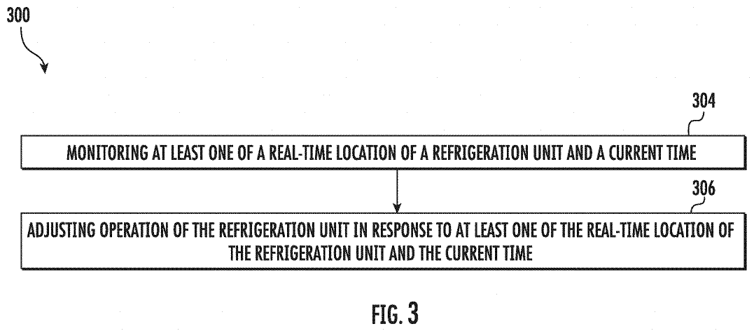

Referring now to FIG. 3, with continued reference to FIGS. 1-2. FIG. 3 shows a flow chart of method 300 of operating a transport refrigeration system 200, in accordance with an embodiment of the disclosure. At block 304, the controller 30 monitors at least one of a real-time location of a refrigeration unit 22 and a current time. In an embodiment, the controller 30 is configured to monitor both the real-time location of the refrigeration unit 22 and the current time. As discussed above, noise regulations may vary depending on the real-time location and/or the time of day. In an embodiment, the controller 30 is configured to monitor either the real-time location of the refrigeration unit 22 or the current time. As discussed above, the real-time location of the refrigeration unit 22 may be monitored by a location tracking device 175, such as, for example a global positioning system.

At block 306, the controller 30 adjusts the operation of the refrigeration unit 22 in response to at least one of the real-time location of the refrigeration unit and the current time. The operation of the refrigeration unit 22 is adjusted to change a level of noise emanating from the refrigeration unit 22. The controller 30 may adjust the operation of the refrigeration unit 22 to reduce the noise emanating from the refrigeration unit 22 when the real-time location is within a selected location. For example, different towns maybe have different noise regulations and thus the operation of the refrigeration unit 22 may need to be adjusted as the refrigeration unit 22 is traveling from one town to another town. The controller 30 may also adjust the operation of the refrigeration unit 22 to reduce the noise emanating from the refrigeration unit 22 at selected times during the day. For example, some town may have stricter noise regulations at night as opposed to during the day. The controller 30 may also adjust the operation of the refrigeration unit 22 when leaving a selected location or after a selected time of day.

While the above description has described the flow process of FIG. 3 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of operating a refrigeration unit of a transport refrigeration system, the method comprising:
monitoring at least one of a real-time location of a refrigeration unit and a current time; and
adjusting operation of the refrigeration unit in response to at least one of the real-time location of the refrigeration unit and the current time,
wherein the operation of the refrigeration unit is adjusted to change a level of noise emanating from the refrigeration unit.

2. The method of claim 1, wherein the operation of the refrigeration unit is adjusted in response to the real-time location of the refrigeration unit.

3. The method of claim 1, wherein the operation of the refrigeration unit is adjusted in response to the current time.

4. The method of claim 1, wherein the operation of the refrigeration unit is adjusted in response to the real-time location of the refrigeration unit and the current time.

5. The method of claim 1, wherein adjusting operation of the refrigeration unit further comprises:
adjusting an RPM of a prime mover configured to power the refrigeration unit.

6. The method of claim 1, wherein adjusting operation of the refrigeration unit further comprises:
adjusting engine load of a prime mover configured to power the refrigeration unit.

7. The method of claim 1, wherein the real-time location of the refrigeration unit is monitored using a global positioning system.

8. A controller for a refrigeration unit of a transport refrigeration system comprising, the controller comprising:
a processor;
a memory comprising computer-executable instructions that, when executed by the processor, cause the processor to perform operations, the operations comprising:
monitoring at least one of a real-time location of a refrigeration unit and a current time; and
adjusting operation of the refrigeration unit in response to at least one of the real-time location of the refrigeration unit and the current time,
wherein the operation of the refrigeration unit is adjusted to change a level of noise emanating from the refrigeration unit.

9. The controller of claim 8, wherein the operation of the refrigeration unit is adjusted in response to the real-time location of the refrigeration unit.

10. The controller of claim 8, wherein the operation of the refrigeration unit is adjusted in response to the current time.

11. The controller of claim 8, wherein the operation of the refrigeration unit is adjusted in response to the real-time location of the refrigeration unit and the current time.

12. The controller of claim 8, wherein adjusting operation of the refrigeration unit further comprises:
adjusting an RPM of a prime mover configured to power the refrigeration unit.

13. The controller of claim 8, wherein adjusting operation of the refrigeration unit further comprises:
adjusting engine load of a prime mover configured to power the refrigeration unit.

14. The controller of claim 8, wherein the real-time location of the refrigeration unit is monitored using a global positioning system.

15. A computer program product tangibly embodied on a computer readable medium, the computer program product including instructions that, when executed by a processor, cause the processor to perform operations comprising:
monitoring at least one of a real-time location of a refrigeration unit and a current time; and
adjusting operation of the refrigeration unit in response to at least one of the real-time location of the refrigeration unit and the current time,
wherein the operation of the refrigeration unit is adjusted to change a level of noise emanating from the refrigeration unit.

16. The computer program product of claim 15, wherein the operation of the refrigeration unit is adjusted in response to the real-time location of the refrigeration unit.

17. The computer program product of claim 15, wherein the operation of the refrigeration unit is adjusted in response to the current time.

18. The computer program product of claim 15, wherein the operation of the refrigeration unit is adjusted in response to the real-time location of the refrigeration unit and the current time.

19. The computer program product of claim 15, wherein adjusting operation of the refrigeration unit further comprises:
adjusting an RPM of a prime mover configured to power the refrigeration unit.

20. The computer program product of claim 15, wherein adjusting operation of the refrigeration unit further comprises:
adjusting engine load of a prime mover configured to power the refrigeration unit.
